(19) United States
(12) Patent Application Publication
(10) Pub. No.: US 2024/0121552 A1
(43) Pub. Date: Apr. 11, 2024

(54) Vibrating Diaphragm for Miniature Sound-Producing Device and Miniature Sound-Producing Device

(71) Applicant: Goertek, Inc., Weifang, Shandong (CN)

(72) Inventors: Bing Hui, Weifang (CN); Fengguang Ling, Weifang (CN); Chun Li, Weifang (CN); Chunfa Liu, Weifang (CN)

(73) Assignee: Goertek, Inc., Weifang, Shandong (CN)

(21) Appl. No.: 17/767,517

(22) PCT Filed: Dec. 24, 2019
(86) PCT No.: PCT/CN2019/128041

§ 371 Date: Apr. 8, 2022

(30) Foreign Application Priority Data
Oct. 31, 2019 (CN) 201911055485.3

(51) Int. Cl. H04R 1/28; C08F 222/30; C08K 3/04; C08L 9/02

(52) U.S. Cl. CPC H04R 1/2811; C08F 222/30; C08K 3/04; C08L 9/02; H04R 2201/029

(57) ABSTRACT

The present disclosure provides a vibrating diaphragm for a miniature sound-producing device and the miniature sound-producing device. The vibrating diaphragm is made of nitrile rubber; the nitrile rubber is prepared by performing cross-linking polymerization on polyacrylonitrile as a polymerization main monomer and a crosslinking monomer which is polybutadiene, and the content of a polyacrylonitrile block of the polymerization main monomer in the nitrile rubber is 10 to 70 wt %. The vibrating diaphragm provided by the present disclosure has more excellent structural stability, anti-polarization capability and low frequency sensitivity. The miniature sound-producing device provided by the present disclosure has more excellent acoustic performance.

### TECHNICAL FIELD

The present disclosure relates to field of electronic product technologies, in particular to a vibrating diaphragm for a miniature sound-producing device and the miniature sound-producing device.

### BACKGROUND

Most existing vibrating diaphragms for miniature sound-producing devices are made of multilayered composite materials, for example: engineering plastics such as PEEK, PAR, PEI and PI, elastomer materials such as TPU and TPEE, and adhesive films such as an acrylic adhesive film and a silica gel adhesive film. In addition, silicone rubber has good thermal stability, good hydrophobic property and excellent resilient property; as such, with the increasing demand for high power, waterproof and high sound quality, silicone rubber is also becoming increasingly popular in manufacturing of vibrating diaphragms.

The abovementioned materials have their respective disadvantages. For example, although the engineering plastics such as PEEK and PAR are relatively good in temperature resistance, they are poor in resilience; as such, products made thereof tend to generate folds and are not conducive to waterproofness. The elastomer materials such as TPU and TPEE are relatively low in melting point and relatively poor in temperature resistance. Although the silicone rubber material is relatively good in thermal stability and resilience, the modulus or hardness of the silicone rubber is relatively low due to its symmetrical chemical structure, high stereo-regularity and small symmetrically substituted methyl steric hindrance, such that the damping property of the material is relatively low, resulting in relatively large distortion of a product made with silicone rubber vibrating diaphragm.

It can be seen that the above vibrating diaphragm is relatively poor in comprehensive performance and cannot meet the demands on comprehensive performance of the miniature sound-producing device. Accordingly, it has become a major challenge in this technical field to provide a vibrating diaphragm with high comprehensive performance and high reliability for the miniature sound-producing device.

### SUMMARY

An object of the present disclosure to provide a vibrating diaphragm for a miniature sound-producing device and the miniature sound-producing device. The vibrating diaphragm has more excellent structural stability, anti-polarization capability and low frequency sensitivity. The miniature sound-producing device has more excellent acoustic performance.

According to a first aspect of the present disclosure, provided is a vibrating diaphragm for a miniature sound-producing device, wherein the vibrating diaphragm is made of nitrile rubber; the nitrile rubber is prepared by performing cross-linking polymerization on polyacrylonitrile as a polymerization main monomer and a crosslinking monomer which is polybutadiene, and the content of a polyacrylonitrile block of the polymerization main monomer in nitrile rubber is 10 to 70 wt %; and

A vulcanizer is blended in the nitrile rubber, a vulcanization system of the vulcanizer includes at least one of a sulfur vulcanization system, a peroxide vulcanization system and a resin vulcanization system, a mass fraction of the nitrile rubber is 100 parts, and a mass fraction of the vulcanizer is 1 to 15 parts.

Optionally, the mass fraction of the vulcanizer is 3 to 10 parts.

Optionally, a reinforcing agent is blended in the nitrile rubber, the reinforcing agent includes at least one of carbon black, silicon dioxide, calcium carbonate, barium sulfate, organic montmorillonite and unsaturated metal carboxylates, the mass fraction of the nitrile rubber is 100 parts, and the mass fraction of the reinforcing agent is 2 to 80 parts.

Optionally, a hardness range of the nitrile rubber vibrating diaphragm is 20 A to 95 A.

Optionally, an antiaging agent is blended in the nitrile rubber, the antiaging agent includes at least one of antiaging agent N-445, antiaging agent 246, antiaging agent 4010, antiaging agent SP, antiaging agent RD, antiaging agent 0DA, antiaging agent OD and antiaging agent WH-02, the mass fraction of the nitrile rubber is 100 parts, and the mass fraction of the antiaging agent is 0.5 to 10 parts.

Optionally, the mass fraction of the antiaging agent is 1 to 5 parts.

Optionally, a bonding force between a nitrile rubber vibrating diaphragm material and an adhesive layer is greater than 100 g/25 mm (stripped at 180°).

Optionally, the vibrating diaphragm is a single-layered vibrating diaphragm which is composed of one nitrile rubber film layer;

Or the vibrating diaphragm is a composite vibrating diaphragm, the composite vibrating diaphragm includes two, three, four or five film layers, and the composite vibrating diaphragm at least includes one nitrile rubber film layer.

Optionally, a thickness of the nitrile rubber film layer is 10 μm to 200 μm.

According to a second aspect of the present disclosure, provided is a miniature sound-producing device, including a miniature sound-producing device main body and the vibrating diaphragm, the vibrating diaphragm being disposed on the miniature sound-producing device main body and is configured to be able to vibrate for sound-producing.

The present disclosure has the following technical effect: the present disclosure discloses a vibrating diaphragm for a miniature sound-producing device and the miniature sound-producing device. The vibrating diaphragm is made of nitrile rubber. The vibrating diaphragm has more excellent structural stability, anti-polarization capability and low frequency sensitivity. The miniature sound-producing device has more excellent acoustic performance.

The exemplary embodiment of the present disclosure is described in detail with reference to the drawings, other features and advantages of the present disclosure will become clearer.

### BRIEF DESCRIPTION OF THE DRAWINGS

The accompanying drawings, which are combined in and constitute a part of this specification, illustrate embodiments of the present disclosure and, together with the description, serve to explain the principles of the present disclosure.

FIG. 1 is a test curve of vibration displacement of different parts of a vibrating diaphragm for a miniature sound-producing device of an embodiment of the present disclosure at different frequencies;

FIG. 2 is a test curve of vibration displacement of different parts of a conventional vibrating diaphragm at different frequencies;

FIG. 3 is a test curve of harmonic distortion (THD) of a vibrating diaphragm of an embodiment of the present disclosure and a conventional PEEK vibrating diaphragm;

FIG. 4 is a HOHD test curve of a vibrating diaphragm of an embodiment of the present disclosure and a conventional PEEK vibrating diaphragm;

FIG. 5 is a stress-strain curve of a vibrating diaphragm of an embodiment of the present disclosure and a conventional PEEK vibrating diaphragm;

FIG. 6 is a test curve (SPL curve) of loudness of a vibrating diaphragm of an embodiment of the present disclosure and a conventional vibrating diaphragm at different frequencies.

### DETAILED DESCRIPTION

Various exemplary embodiments of the present invention will be described in detail now with reference to the accompanying drawings. It should be noted that the relative arrangement, numerical expressions and values of components and steps described in these embodiments do not limit the scope of the present invention unless otherwise specified.

The following description of at least one exemplary embodiment is merely illustrative in nature and in no way serves as any limitation of the present invention and its application or uses.

Techniques, methods, and apparatuses known to those of ordinary skill in the related field may not be discussed in detail but, where appropriate, should be considered a part of the description.

In all examples shown and discussed herein, any specific value should be interpreted as merely exemplary and not as a limitation. Therefore, other examples of the exemplary embodiments may have different values.

It should be noted that similar reference numerals and letters in the following drawings represent similar items, and therefore, once an item is defined in one drawing, the item does not need to be further discussed in subsequent drawings.

The present disclosure provides a vibrating diaphragm for a miniature sound-producing device, and the vibrating diaphragm is made of nitrile rubber. The nitrile rubber is prepared by performing cross-linking polymerization on polyacrylonitrile as a polymerization main monomer and a crosslinking monomer, and the crosslinking monomer is polybutadiene.

Specifically, a molecular structural formula of the nitrile rubber is as follows:

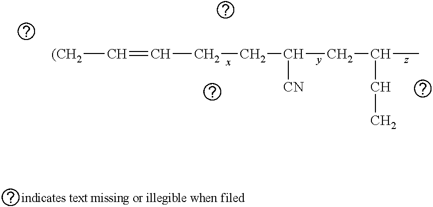

In the above molecular formula, x, y and z are natural numbers.

Optionally, the content of a polyacrylonitrile block of the polymerization main monomer in nitrile rubber is 10 to 70 wt %.

A polybutadiene block provides toughness in a material matrix, such that the rubber has relatively good low-temperature resistance. If the content of the polybutadiene block is too high, the rigidity of the nitrile rubber is not enough, which hardly meets a using requirement. If the content of the polybutadiene block is too low, i.e., the content of the polyacrylonitrile block is too high, as nitrile grouping in the polyacrylonitrile block is a strongly polar radical, has relatively high electronegativity and can form a hydrogen bond with atoms in a vulcanizer, such that movement of a molecular chain is limited. The higher the content of acrylonitrile is, the more the alternating structure units arc. Thus, along with rise of the content of the polyacrylonitrile block, the glass-transition temperature and the tensile strength of the nitrile rubber (NBR) are raised gradually.

The nitrile rubber vibrating diaphragm provided by the present disclosure is in a high-elastic state at room temperature, the molecular chain is easy to move, the intermolecular friction force is large, the vibrating diaphragm has a better damping property, and the loss factor thereof at room temperature is greater than 0.06, preferably greater than 0.1 by controlling the content of the polyacrylonitrile block in the nitrile rubber within 10 to 70 wt %.

Due to the excellent damping property, the vibrating diaphragm has a lower quality of factor Q. The damping property of the vibrating diaphragm is improved, and a vibrating system is high in ability of inhibiting a polarization phenomenon in a vibrating process, such that the vibrating consistence is good. The conventional engineering plastic vibrating diaphragm is low in damping, the loss factor thereof is usually smaller than 0.01, and the damping property is small.

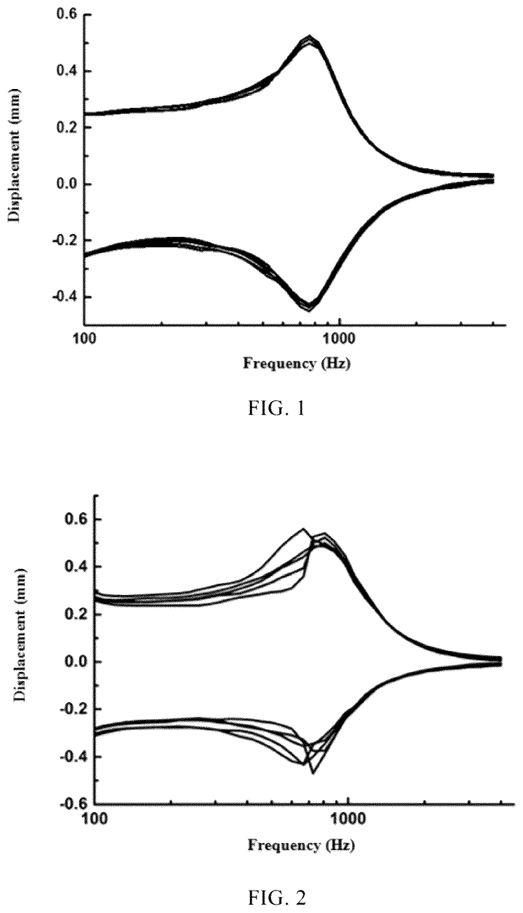

FIG. 1 is a test curve of vibration displacement of different parts of the vibrating diaphragm for the miniature sound-producing device of an embodiment of the present disclosure at different frequencies. FIG. 2 is a test curve of vibration displacement of different parts of a conventional vibrating diaphragm at different frequencies.

The vibrating diaphragm is a rectangular vibrating diaphragm with a corrugated rim. The transverse coordinate is frequency (Hz) and the vertical coordinate is loudness displacement (mm). Points in an edge position and a center position of a center portion of the vibrating diaphragm are got to test.

It can be seen that the curves in the FIG. 1 are more centralized and the curves in the FIG. 2 are relatively dispersed. It verifies that the respective parts of the vibrating diaphragm of the embodiment of the present disclosure are better in vibrating consistence. In the vibrating process, rocking vibration of the vibrating diaphragm is less, and the tone quality and audition stability are more excellent.

Compared with the engineering plastics, the nitrile rubber vibrating diaphragm with the content of the polyacrylonitrile block within 10 to 70 wt % provided by the disclosure has a relatively wide elastic area. When strain of the vibrating diaphragm occurs in the area, the vibrating diaphragm is excellent in resilience after removing an external force. The vibrating diaphragm is less in rocking vibration in the vibrating process and is more excellent in tone quality and audition stability.

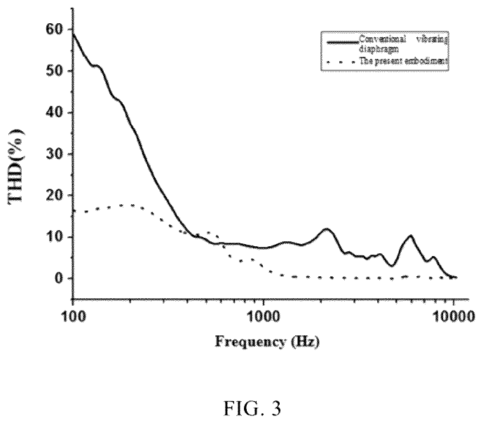

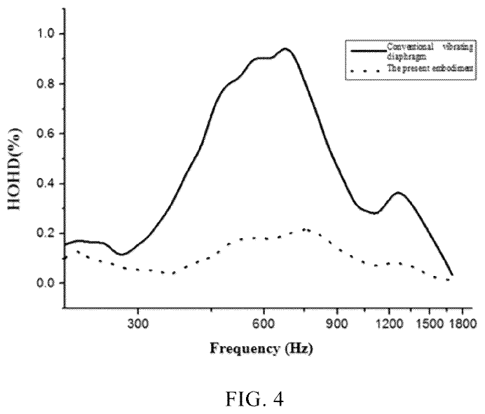

FIG. 3 and FIG. 4 are THD and HOHD test curves of the vibrating diaphragm of an embodiment of the present disclosure and the conventional PEEK vibrating diaphragm. It can be seen from the FIG. 3 that compared with the conventional PEEK vibrating diaphragm, the vibrating diaphragm of the embodiment of the present disclosure has a lower THD (total harmonic distortion). It can be seen from the FIG. 4 that the vibrating diaphragm of the embodiment of the present disclosure is free of peak. It verifies that the vibrating diaphragm of the present disclosure has a more excellent anti-polarization capability and is more excellent in tone quality.

Optionally, a vulcanizer is blended in the nitrile rubber, a vulcanization system of the vulcanizer includes at least one of a sulfur vulcanization system, a peroxide vulcanization system and a resin vulcanization system, and the vulcanizer specifically includes at least one of a trisulfhydryl triazine vulcanization system, polyamine, an organic acid, an ammonium salt, an organic acid ammonium salt, dithiocar-bamate, imidazole/anhydride, isocyanuric acid/quaternary salt, sulfur/accelerant and peroxide. The resin vulcanization system can perform crosslinking for a polymer containing unsaturated bonds such as double bonds and ether bonds, and is short in vulcanization time and high in vulcanization efficiency, and meanwhile, the heat resistance and flexural resistance of the polymer can be improved, and there is nearly no vulcanizing restoration phenomenon during vulcanization.

The vulcanizer is added, which is conducive to form a crosslinking point in the nitrile rubber, thereby improving the crosslinking degree of the polymer. Along with increase of dosage of the vulcanizer, the crosslinking degree of the nitrile rubber is improved, the movement of the molecular chain is limited, the glass-transition temperature is increased, and the elongation at break is reduced. Therefore, when the mass fraction of the nitrile rubber is 100 parts, it is necessary to control the mass fraction of the vulcanizer at 1 to 15 parts. Preferably, the mass fraction of the vulcanizer is 3 to 10 parts. Under the circumstance of the above mass fraction, it is not only guaranteed that the nitrile rubber has a proper crosslinking degree, but also meets the requirements on glass-transition temperature and mechanical property of the nitrile rubber vibrating diaphragm material.

The content of the polyacrylonitrile block in nitrile rubber and the added parts of the vulcanizer directly affect the glass-transition temperature and the tensile strength of the nitrile rubber. Under a condition of certain added parts of the vulcanizer, the content of polyacrylonitrile block in nitrile rubber is positively related to the glass-transition temperature and tensile strength of the nitrile rubber. Specific corresponding data is as shown in the table 1.

TABLE 1
Relationship between the content of polyacrylonitrile
block in nitrile rubber and the glass-transition temperature
and the tensile strength of the nitrile rubber

| | Content of the polyacrylonitrile block (wt %) | | | |
|---|---|---|---|---|
| | 8 | 10 | 70 | 76 |
| Glass-transition | −36.3 | −34.4 | −23.8 | −18.1 |
| temperature (° C.) | | | | |
| Tensile strength (MPa) | 23.2 | 24.9 | 28.6 | 34.1 |

As the nitrile rubber has relatively high molecular weight and is relatively good in low-temperature resistance because the molecular chain thereof is relatively flexible, on this basis, in order to keep the high-elastic state and good resilience of the nitrile rubber vibrating diaphragm at normal temperature, it is necessary to control the glass-transition temperature thereof within a range of minus 50° C. to 0° C. Within a certain range, as the glass-transition temperature is lower, the vibrating diaphragm can work normally at a lower temperature.

In order to keep relatively good rubber elasticity of the nitrile rubber vibrating diaphragm during work at a temperature lower than 0° C. so that the miniature sound-producing device shows a relatively good tone quality and the risk that the vibrating diaphragm is damaged in a low-temperature environment is reduced, it is necessary to control the glass-transition temperature of the nitrile rubber vibrating diaphragm in a range of minus 45° C. to minus 20° C., that is, it is necessary to control the content of the polyacrylonitrile block in the nitrile rubber within the range of 10 to 70 wt %.

Optionally, the content of the polyacrylonitrile block in the nitrile rubber and the added parts of the vulcanizer directly affect the toughness of the nitrile rubber. The nitrile rubber vibrating diaphragm with proper added parts of vulcanizer and the content of polyacrylonitrile block in a range of 10 to 70 wt % has excellent toughness, the elongation at break is greater than 150%, preferably greater than 180%, and the vibrating diaphragm has relatively high elongation at break, such that the vibrating diaphragm is not prone to having the reliability problems such as rupture of the diaphragm when being used in the miniature sound-producing device.

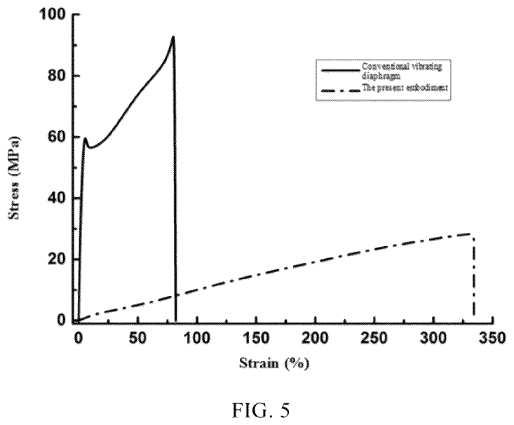

FIG. 5 is a stress-strain curve of the vibrating diaphragm of an embodiment of the present disclosure and a conventional PEEK vibrating diaphragm. It can be seen from FIG. 5 that under a same stress, the strain of the vibrating diaphragm provided by the embodiment of the present disclosure is obviously greater than that of the conventional PEEK vibrating diaphragm. It verifies that the Young modulus of the vibrating diaphragm provided by the embodiment of the present disclosure is obviously smaller than that of the conventional PEEK vibrating diaphragm.

In addition, the PEEK vibrating diaphragm forms an obvious yield point which is about 0.4 to 0.5% of strain. The vibrating diaphragm provided by the present disclosure is free of yield point, which verifies that the vibrating diaphragm provided by the present disclosure has a wider elastic area and excellent resilience.

The nitrile rubber vibrating diaphragm has good flexibility, for example, the elongation at break is greater than or equal to 150%. The polyacrylonitrile block has important influence on elongation at break and those skilled in the art can select according to an actual need. The vibration displacement of the vibrating diaphragm is larger and the loudness is higher. Further, it is good in reliability and durability. The better the flexibility of the vibrating diaphragm material is, the greater the elongation at break is, and the higher the ability of the vibrating diaphragm resisting damage is. When the vibrating diaphragm vibrates in a large vibrating amplitude state, the vibrating diaphragm material generates relative large strain, and the vibrating diaphragm material has the risk of diaphragm fold, diaphragm rupture or diaphragm damage during long-time vibration. The vibrating diaphragm of the present disclosure taking nitrile rubber as a base material has good flexibility, and the risk that the vibrating diaphragm is damaged is reduced.

Optionally, under the circumstance that the proper parts of vulcanizer are added into nitrile rubber and the content of the polyacrylonitrile block is in a range of 10 to 70 wt %, as the nitrile rubber vibrating diaphragm material has a stable crosslinking structure, the vibrating diaphragm has a relatively high using temperature range, can work continuously for 3 days at 150° C. and can meet the demand of the miniature sound-producing device on high and low temperatures, such that the risk of structural collapse due to overtemperature in actual use is avoided.

Optionally, a reinforcing agent is blended in the nitrile rubber, the reinforcing agent includes at least one of carbon black, silicon dioxide, calcium carbonate, barium sulfate, organic montmorillonite and unsaturated metal carboxylates. Under a circumstance that the mass fraction of the nitrile rubber is 100 parts, the mass fraction of the reinforcing agent is 2 to 80 parts. Preferably, the mass fraction of the reinforcing agent is 5 to 60 parts.

The surface of the reinforcing agent has radicals such as hydrogen, carboxyl, lactonyl, free radical, quinonyl and the like capable of being substituted, reduced, oxidized and the like. After the reinforcing agent is blended into the nitrile rubber, as a result of a strong interaction between the reinforcing agent and an interface of the polymer block of the nitrile rubber, the molecular chain is relatively prone to sliding on the surfaces of microparticles of the reinforcing agent when the nitrile rubber is stressed, but is not prone to being separated from the microparticles of the reinforcing agent. The nitrile rubber and the microparticles of the reinforcing agent form a strong bond capable of sliding, such that the mechanical strength is increased.

Taking carbon black as an example: carbon black is of an amorphous structure, and particles form an aggregate by means of physical and chemical combination between each other. The primary structure of carbon black is formed by the aggregates, and meanwhile, the aggregates having Van der Waals' force or hydrogen bonds can be aggregated to form a spatial network structure, i.e., a secondary structure of carbon black. The surface of the carbon black has the above radicals. The microparticles of the carbon black and the molecular chain of the polymer can form the above relationship, such that the mechanical strength of the nitrile rubber is improved.

The strength of the nitrile rubber material is adjusted primarily by mixing the reinforcing agent. But if the mechanical strength is too high, the resonant frequency of the miniature sound-producing device is too high, and the low-frequency responsiveness is reduced. Optionally, the hardness range of the nitrile rubber vibrating diaphragm is 20 A to 95 A, preferably 25 to 80 A. The mechanical strength of the nitrile rubber vibrating diaphragm can reach 0.5 to 50 MPa, preferably 2 to 35 MPa, at room temperature.

The resonant frequency F0 of the miniature sound-producing device is in direct proportion to the modulus and thickness of the vibrating diaphragm. As far as nitrile rubber is concerned, a modulus thereof is in direct proportion to hardness. Thus, the modulus of the nitrile rubber vibrating diaphragm can be reflected by hardness. The higher the strength and hardness of the rubber vibrating diaphragm material are, the higher the F0 of the vibrating diaphragm material is, which leads to reduction of loudness of the miniature sound-producing device and deterioration of low pitch. Table 2 shows the F0 Values of the vibrating diaphragms with same thickness but different hardness. It can be seen from the table 2 that F0 is increased rapidly as the hardness of the vibrating diaphragm material is increased.

TABLE 2
F0 Values of the vibrating diaphragms with
same thickness but different hardness

| Hardness (A) | 20 | 25 | 60 | 80 | 90 |
|---|---|---|---|---|---|
| F0 (Hz) | 543 | 603 | 762 | 962 | 1123 |

The vibrating diaphragm for a miniature sound-producing device provided by the present disclosure is a vibrating diaphragm with a corrugated rim, or a plate vibrating diaphragm. The resonant frequency F0 of the miniature sound-producing device is in direct proportion to the Young modulus and thickness of the vibrating diaphragm, and change of F0 can be realized by changing the thickness and the Young modulus of the vibrating diaphragm. A specific adjusting principle is as follows:

$$F 0 = \frac{1}{2 π} \sqrt{\frac{1}{CmsMms}}$$

Wherein Mms is equivalent vibrating mass of the miniature sound-producing device, and Cms is equivalent compliance of the miniature sound-producing device;

$$Cms = \frac{( {C}_{m 1} * {C}_{m 2} )}{( {C}_{m 1} + {C}_{m 2} )}$$

Wherein Cm₁ is damper compliance and Cm₂ is vibrating diaphragm compliance. In a design without a damper, the equivalent compliance of the miniature sound-producing device is vibrating diaphragm compliance;

$${C}_{m 2} = \frac{( 1 - {u}^{3} ) {W}^{3}}{π ( W + dvc ) {t}^{3} {Ea}_{1} {a}_{2}}$$

Wherein W is total width of a corrugated rim part of the vibrating diaphragm, t is the thickness of the diaphragm, dvc is the fitting outer diameter of a voice coil fitted on the vibrating diaphragm, E is the Young modulus of the vibrating diaphragm material, a1 and a2 are correction coefficients, the value of a₁ is dependent on shape of the vibrating diaphragm base material, a₂ is equal to h (corrugated rim height)/W, and u is the Poisson ratio of the vibrating diaphragm material.

It can be seen that in order to obtain full low pitch and comfortable hearing feeling, the vibrating diaphragm has enough rigidity and damping while the miniature sound-producing device has relatively low F0. Those skilled in the art can adjust the amplitude of F0 by adjusting hardness and thickness of the vibrating diaphragm. Preferably, the shore hardness of the vibrating diaphragm is 25 to 80 A. The thickness of the vibrating diaphragm is 30 to 120 μm. The resonant frequency F0 of the miniature sound-producing device can reach 150 to 1500 Hz. The low frequency performance of the miniature sound-producing device is excellent.

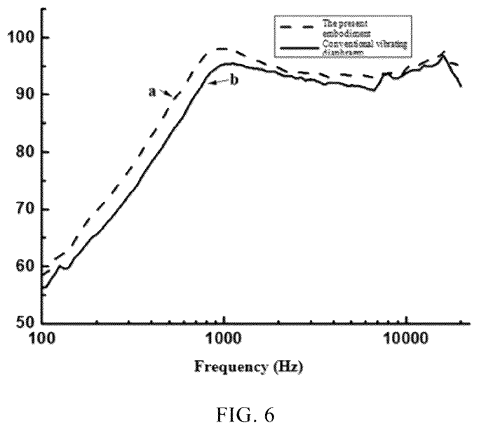

FIG. 6 is a test curve (SPL curve) of loudness of the vibrating diaphragm of an embodiment of the present disclosure and a conventional vibrating diaphragm at different frequencies. The vibrating diaphragm is the vibrating diaphragm with a corrugated rim. The transverse coordinate is frequency (Hz) and the vertical coordinate is loudness.

It can be seen from the FIG. 6 that the low frequency performance of the vibrating diaphragm provided by the embodiment of the present disclosure is 2-3 dB higher than that of the conventional vibrating diaphragm and the medium frequency performance thereof is 0.5-1 dB higher than that of the conventional vibrating diaphragm. The F0 of the miniature sound-producing device adopting the vibrating diaphragm of the embodiment of the present disclosure is 786 Hz which is at “a” in the FIG. 6, and F0 of the miniature sound-producing device adopting the conventional vibrating diaphragm is 886 Hz which is at “b” in the FIG. 6. It verifies that the low frequency sensitivity of the vibrating diaphragm in the embodiment is higher than that of the conventional vibrating diaphragm. That is, the miniature sound-producing device adopting the vibrating diaphragm of the embodiment of the present disclosure is higher in loudness and comfort level.

Optionally, an antiaging agent is blended in the nitrile rubber. The antiaging agent includes at least one of antiaging agent N-445, antiaging agent 246, antiaging agent 4010, antiaging agent SP, antiaging agent RD, antiaging agent ODA, antiaging agent OD and antiaging agent WH-02.

In a using process of nitrile rubber, along with extension of time, the molecular chain of nitrile rubber is broken to generate dissociative free radicals, and the phenomenon is a natural ageing phenomenon of the nitrile rubber. By blending the antiaging agent in the nitrile rubber, an autocatalytic phenomenon of the active free radicals generated in nitrile rubber can be prevented or suspended and alleviated.

When the added amount of the antiaging agent is too small, an effect of prolonging the service life of the nitrile rubber is not reached. By adding more antiaging agent, the mechanical property of the nitrile rubber material may be reduced as the antiaging agent cannot be better inter-dissolved with the nitrile rubber elastomer and is difficult to disperse uniformly. Therefore, under a condition that the mass fraction of the nitrile rubber is 100 parts, it is necessary to control the mass fraction of the antiaging agent at 0.5 to 10 parts. Optionally, the mass fraction of the antiaging agent is 1 to 5 parts.

Optionally, as the molecular structure of the nitrile rubber vibrating diaphragm material contains a lot of nitrile grouping which can form hydrogen bond action with the adhesive layer, the nitrile rubber vibrating diaphragm material has an excellent bonding property. A bonding force between the nitrile rubber vibrating diaphragm material and the adhesive layer is greater than 100 g/25 mm (stripped at 180°). Preferably, the bonding force is greater than 200 g/25 mm. The nitrile rubber vibrating diaphragm is good in coordinating consistence with Dome in the vibrating process due to a relatively high bonding force, is pure in tone quality, is still kept in an initial state after long-time vibration and is high in performance stability.

Optionally, the vibrating diaphragm is either a single-layered vibrating diaphragm or a multilayered composite vibrating diaphragm. The single-layered vibrating diaphragm is formed by one nitrile rubber film layer, and the composite vibrating diaphragm is the vibrating diaphragm formed by stacking multiple nitrile rubber film layers in sequence. Alternatively, the composite vibrating diaphragm can include at least one nitrile rubber film layer, and the nitrile rubber film layer is compounded with the film layer prepared by other materials layer by layer to form the composite vibrating diaphragm prepared by various materials. The composite vibrating diaphragm includes two, three, four or five film layers, which is not limited here.

The thickness of the nitrile rubber film layer is 10 μm to 200 μm, preferably 30 μm to 120 μm. When the thickness of the nitrile rubber film layer is in the range, performance requirement of the miniature sound-producing device and requirement on assembling space can be better met.

Optionally, the nitrile rubber vibrating diaphragm is prepared by way of mold pressing-injection molding or air pressure molding. As the nitrile rubber vibrating diaphragm has very low glass-transition temperature and the vibrating diaphragm material is good in strength and toughness, the nitrile rubber vibrating diaphragm can be used for a long time at a high temperature. The vibrating diaphragm can be formed rapidly by way of simple mold pressing-injection molding or air pressure molding, such that the production efficiency is improved.

The present disclosure further provides a miniature sound-producing device, including a miniature sound-producing device main body and the vibrating diaphragm made of nitrile rubber, the vibrating diaphragm being disposed on the miniature sound-producing device main body and is configured to be able to vibrate for sound-producing. The miniature sound-producing device main body can be provided therein with components such as a coil and a magnetic circuit system, and the vibrating diaphragm is driven by electromagnetic induction to vibrate.

Although detailed description has been made on some specific embodiments of the present disclosure through examples, those skilled in the art shall understand that the examples are merely used for explanation rather than limitation of the scope of the present disclosure. Those skilled in the art shall understand that modifications on the embodiment can be made without departing the scope or the spirit of the present disclosure. The scope of the present disclosure is limited by the appended claims.

1. A nitrile rubber vibrating diaphragm for a miniature sound-producing device, comprising:
a polyacrylonitrile polymerization main monomer cross-linked with a polybutadiene crosslinking monomer, wherein a polyacrylonitrile block of the polymerization main monomer in the nitrile rubber is 10 to 70 wt %; and
a vulcanizer selected from the group consisting of a sulfur vulcanizer, a peroxide vulcanizer and a resin vulcanizer, wherein a mass fraction of the nitrile rubber is 100 parts, and a mass fraction of the vulcanizer is 1 to 15 parts.

2. The nitrile rubber vibrating diaphragm of claim 1 for a miniature sound-producing device, wherein the mass fraction of the vulcanizer is 3 to 10 parts.

3. The nitrile rubber vibrating diaphragm of claim 1 for a miniature sound-producing device, further comprising a reinforcing agent including at least one of carbon black, silicon dioxide, calcium carbonate, barium sulfate, organic montmorillonite and unsaturated metal carboxylates, wherein the mass fraction of the nitrite rubber is 100 parts, and the mass fraction of the reinforcing agent is 2 to 80 parts.

4. The nitrile rubber vibrating diaphragm of claim 3 for a miniature sound-producing device, wherein a hardness range of the vibrating diaphragm is 20 A to 95 A.

5. The nitrile rubber vibrating diaphragm of claim 1 for a miniature sound-producing device, further comprising an antiaging agent is comprisinge at least one of antiaging agent N-445, antiaging agent 246, antiaging agent 4010, antiaging agent SP, antiaging agent RD, antiaging agent ODA, antiaging agent OD and antiaging agent WH-02, wherein the mass fraction of the nitrile rubber is 100 parts, and the mass fraction of the antiaging agent is 0.5 to 10 parts.

6. The nitrile rubber vibrating diaphragm of claim 5 for a miniature sound-producing device, wherein the mass fraction of the antiaging agent is 1 to 5 parts.

7. The nitrile rubber vibrating diaphragm of claim 1 for a miniature sound-producing device, wherein the nitrile rubber vibrating diaphragm is adapted to have a bonding force to an adhesive layer greater than 100 g/25 mm when stripped at 180°.

8. The nitrile rubber vibrating diaphragm of claim 1 for a miniature sound-producing device, wherein the nitrile rubber vibrating diaphragm is selected from the group consisting of a single-layered vibrating diaphragm having one nitrile rubber film layer
and a composite vibrating diaphragm comprising at least two film layers, including at least one nitrile rubber film layer.

9. The nitrile rubber vibrating diaphragm of claim 8 for a miniature sound-producing device, wherein a thickness of the nitrile rubber film layer is 10 μm to 200 μm.

10. A miniature sound-producing device, comprising a miniature sound-producing device main body and the nitrile rubber vibrating diaphragm of claim 1, the nitrile rubber vibrating diaphragm being disposed on the miniature sound-producing device main body and is configured to vibrate for sound-producing.
